(19) United States
(12) Patent Application Publication
(10) Pub. No.: US 2010/0018503 A1
(43) Pub. Date: Jan. 28, 2010

(54) Upper guide system for solenoid actuated fuel injectors

(76) Inventors: Robert B. Perry, Leicester, NY (US); Charles W. Braun, Livonia, NY (US); Kevin J. Allen, Avon, NY (US)

Correspondence Address: Delphi Technologies, Inc., M/C 480-410-202, PO BOX 5052, Troy, MI, 48007, US

(21) Appl. No.: 12/220,139

(22) Filed: Jul. 22, 2008

(51) Int. Cl. F02M 51/06

(52) U.S. Cl. 123/472; 251/129.15; 239/585.1

(57) ABSTRACT

An upper guide system for a solenoid actuated fuel injector of an internal combustion engine includes an armature and a guide ring having a cylindrical shape and surrounding the armature and positioning the armature in a radial direction. The location of the upper guide system is substantially in the same axial location as the radial magnetic forces imposed on the armature. Features such as flutes or grooves are disposed on an outer diameter surface of the armature and/or holes through a body portion of the armature. Accordingly, the response performance of the solenoid actuated fuel injector is improved.

### TECHNICAL FIELD

The present invention relates to fuel injection systems for internal combustion engines; more particularly, to solenoid actuated fuel injectors; and most particularly, to a ring guided armature of the injector including armature features that enable improved injector performance.

### BACKGROUND OF THE INVENTION

Fuel injected internal combustion engines are well known. Fuel injection arrangements may be divided generally into multi-port fuel injection (MPFI), wherein fuel is injected into a runner of an air intake manifold ahead of a cylinder intake valve, and direct injection (DI), wherein fuel is injected directly into the combustion chamber of an engine cylinder, typically during or at the end of the compression stroke of the piston. DI is designed to allow greater control and precision of the fuel charge to the combustion chamber, resulting in better fuel economy and lower emissions. This is accomplished by the combustion of a precisely controlled charge of fuel under various operating conditions. DI is also designed to allow higher cylinder compression ratios, delivering higher performance with lower fuel consumption compared to other fuel injection systems.

Generally, an electromagnetic fuel injector incorporates a solenoid armature/pintle assembly, located between the pole piece of the solenoid and a fixed valve seat. The armature/pintle assembly typically operates as a movable valve assembly and, therefore, represents the moving mass of the fuel injector. Electromagnetic fuel injectors of the pulse width type meter fuel per electric pulse at a rate of flow proportional to the width of the electric pulse. In a normally closed injector, when an injector is de-energized, its movable valve assembly is released from one stop position and accelerated by a spring towards the opposite stop position, located at the valve seat to close the valve.

As the magnetic forces act radially on the armature to open the valve, the moving mass of a fuel injector must be guided in its radial direction to keep the pintle axially aligned with the seat in order for flow control across the seat to be robust and precise. Further, controlled axial alignment of the pintle helps to reduce wear between the pole piece and armature, and between the pintle and seat to provide a fuel flow rate within an established tolerance for the life of the components of the armature/pintle assembly. Thus, the guidance of the moving mass of the fuel injector is critical to function, performance, and durability of the injector. Moreover, DI injectors require a relatively high fuel pressure to operate that may be, for example, as high as about 4000 psi compared to about 60 psi required to operate a typical MPFI injector. Due to the higher operating pressure, the fuel flow of DI injectors is more sensitive to variations in the axial movement and alignment of the armature/pintle assembly than MPFI injectors.

Several methods to control the alignment of the moving mass of a fuel injector are currently employed. For example, in some cases, the pintle itself is used as the guide surface. However, since the guide location is axially distanced from the location of the radial load imposed on the armature by the magnetic forces, the friction imposed on the moving mass in the area of the guide surface can be high.

In other prior art guide systems, the outside diameter of the armature is used as the guide surface. While this locates the guide surface at the same axial location as the magnetic radial forces imposed on the armature, the surface area of the outside diameter of the armature that makes contact with the guide is much greater adding to the frictional losses imposed on the moving mass and contributing to a reduction in injector response time.

What is needed in the art is an upper guide system for the moving mass of a solenoid actuated injector that aligns the upper guide location with the location of the radial forces imposed on the armature and that reduces the contact area at the guide point to reduce friction.

It is a principal object of the present invention to provide an upper guide system of a solenoid actuated injector with a reduced surface contact area.

### SUMMARY OF THE INVENTION

Briefly described, an upper guide system for the moving mass of a solenoid-actuated injector includes a ring guided upper guide system that serves to position the armature of the solenoid in a radial direction. The location of the upper guide system is closely aligned with the radial magnetic forces acting on the armature.

The ring guided upper guide system in accordance with the invention includes a guide ring having a hard surface possessing relatively good wear properties. The armature is preferably plated with a relatively hard material as well to reduce wear between the armature and guide ring.

Further, the armature in accordance with the invention includes features that reduce the area of contact of the guide system. The reduced contact area diminishes the hydraulic or viscous drag between the armature and the guide ring. Accordingly, these features improve the performance of the injector compared to injectors with prior art guide systems.

In one aspect of the invention, the features having a variety of shapes and sizes are disposed on the outside diameter surface of the armature. In another aspect of the invention, other features are formed through the body of the armature to improve injector performance. A combination of these features may be incorporated in a single armature. The features incorporated in the armature in accordance with the invention for reducing the area of contact may include grooves or flutes that run in an axial direction along the outer diameter surface of the armature; the flutes may be straight or helical. The features may also be one or more circumferential grooves on the outer diameter surface of the armature. The other features to improve injector performance may include axial or radial holes formed in the armature.

By including these features in the armature, separately or in combination, the suction forces between the armature and pole piece when the injector is de-energized, and/or the viscous tension between the armature and guide surfaces are reduced thereby improving injector response time. Further, through the strategic placement of these features, the magnetic flux density and the eddy current formation around the armature may be tuned. Also, by incorporating these features into the armature, a reduction in moving mass and an improvement in fuel flow past the armature can be realized.

### BRIEF DESCRIPTION OF THE DRAWINGS

The present invention will now be described, by way of example, with reference to the accompanying drawings, in which:

FIG. 1 is a cross-sectional view of a solenoid actuated fuel injector, in accordance with a first embodiment of the invention;

FIG. 2 is a schematic diagram of the reaction forces acting on an armature pintle assembly of the solenoid actuated fuel injector, in accordance with the first embodiment of the invention;

FIG. 3 is a top plan view of an armature pintle assembly of the fuel injector, in accordance with a second embodiment of the invention; and

FIG. 4 is a cross-sectional view along line 4-4 of the armature pintle assembly of the fuel injector, in accordance with the second embodiment of the invention.

Corresponding reference characters indicate corresponding parts throughout the several views. The exemplification set out herein illustrates preferred embodiments of the invention, in one form, and such exemplification is not to be construed as limiting the scope of the invention in any manner.

### DESCRIPTION OF THE PREFERRED EMBODIMENTS

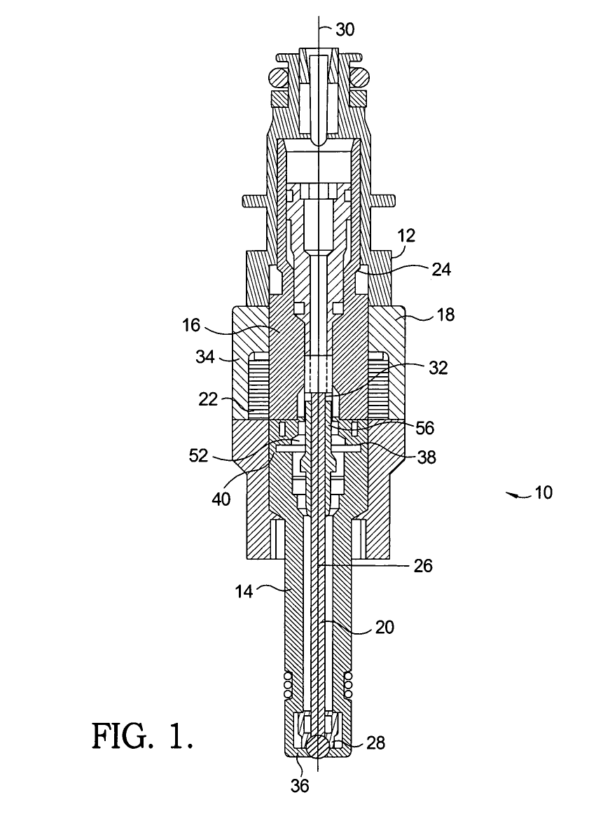

Referring to FIG. 1, a solenoid actuated fuel injector 10 includes an upper housing 12, a lower housing 14, a pole piece 16 positioned between upper housing 12 and lower housing 14, an actuator housing 18 connecting upper housing 12 with lower housing 14, an armature/pintle assembly 20, and a coil assembly 22 surrounding pole piece 16. Upper housing 12, lower housing 14, and pole piece 16 enclose a fuel passage 24. Pole piece 16 may be chromium plated to reduce wear caused by the pole piece being impacted by the armature/pintle assembly 20. Fuel injector 10 may be a fuel injector for direct injection.

Armature/pintle assembly 20 includes a pintle 26, a valve 28, such as for example a ball, and an armature 40. Armature 40 is secured to a first end of pintle 26, for example, by using a weld block 32. Valve 28 is fixed at an opposite end of pintle 26. Armature pintle assembly 20 constitutes the moving mass of fuel injector 10. Armature/pintle assembly 20 is assembled within lower housing 14 for reciprocating movement in an axial direction along axis 30 within fuel passage 24. A spring 34, for biasing valve 28 toward its mating seat 36, may be positioned in a center bore formed in pole piece 16 above armature/pintle assembly 20. Solenoid actuated fuel injector 10 meters fuel per electric pulse that is applied to coil assembly 22 at a rate proportional to the width of the electric pulse. When injector 10 is de-energized, movable armature/pintle assembly 20 is released from a first stop position where armature 40 is in contact with pole piece 16 and is accelerated by spring 34 and the fuel pressure in passage 24 towards the opposite second stop position, located at the valve seat 36 integrated into lower housing 14. The distance in which valve 28 travels between the first and the second stop position constitutes the stroke of fuel injector 10.

In accordance with the present invention, fuel injector 10 further includes a guide ring 38 as part of an upper guide system for armature/pintle assembly 20. Guide ring 38 has a cylindrical shape and surrounds armature 40. The outer diameter of guide ring 38 is adapted to closely fit into an inner circumferential contour of lower housing 14 so as to be secured in place by the housing. The inner diameter of guide ring 38 is adapted to receive armature 40 with a minimal circumferential air gap between the armature and guide ring. Accordingly, guide ring 38 is positioned between armature 40 and lower housing 14 and, therefore, in substantially the same axial location as the radial magnetic forces acting on armature 40 when the solenoid is energized. Guide ring 38 may be assembled in a fixed position relative to lower housing 14, for example, by welding. Armature 40 is reciprocably movable within guide ring 38 and, because of the minimal clearance between guide ring 38 and armature 40, guide ring 38 positions armature 40 in a radial direction to thereby align the armature/pintle assembly 20 relative to the contact surfaces of pole piece 16 and seat 36. The contact surface of guide ring 38 is hard and may be formed, for example, of a martensitic stainless steel or be chrome plated, thereby providing relatively good wear properties. The surface of the guide ring proximate the armature preferably has a smooth finish that can be achieved, for example, by grinding. To reduce wear at the interface between armature 40 and guide ring 38, armature 40 may be plated with a relatively hard material, such as chromium or titanium nitride. Fuel in fuel passage 24 moving towards valve seat 36 lubricates the bearing area between armature 40 and guide ring 38. While guide ring 38 has been shown and described as placed within lower housing 14, it may be possible to assemble guide ring 38 in another part of the housing of fuel injector 10 so as to be aligned with the armature, such as, for example, actuator housing 18.

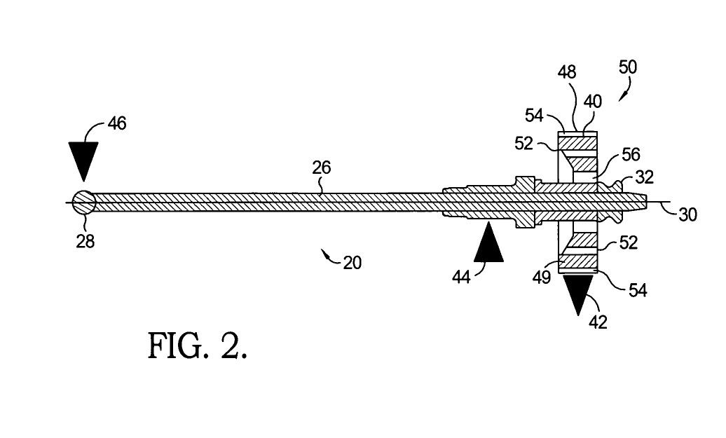

Referring to FIG. 2, reaction forces acting on armature pintle assembly 20 of solenoid actuated fuel injector 10 typically include a radial magnetic force 42, a pintle-to-lower housing contact reaction force 44, and a valve reaction force 46. By including guide ring 38 in the assembly of fuel injector 10 and by positioning guide ring 38 to be aligned with radial magnetic force 42 as shown in FIG. 1, lateral movement of armature 40, in the direction of arrow 42, can be reduced compared to prior art fuel injector assemblies without guide ring 38. Furthermore, including guide ring 38 in the assembly of fuel injector 10 reduces or eliminates pintle contact reaction force 44 compared to prior art fuel injector assemblies and reduces valve reaction force 46 because lateral movement of the armature is limited.

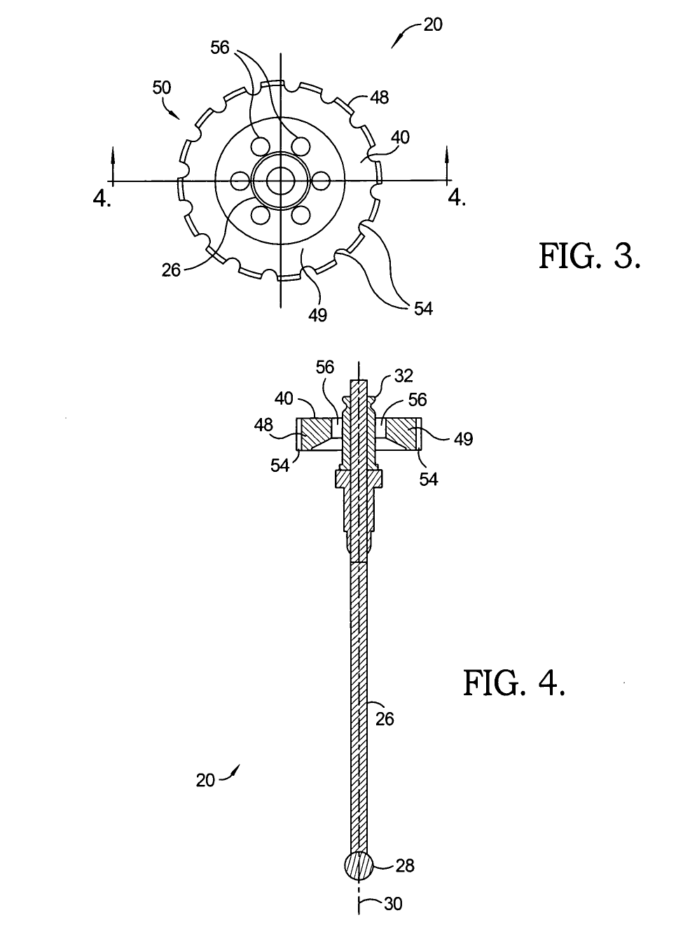

Armature 40 includes features 50, such as through holes 52 shown in FIGS. 1 and 2 or flutes 54 on the outer diameter surface of armature 40 shown in FIGS. 3 and 4. Features 50 reduce the hydraulic or viscous drag imposed on the armature by the surface tension of the fuel between the pole piece and armature and the surfaces of the guide and the armature, thereby improving the response time of the injector. The features also enable tuning of the magnetic flux density and eddy current formation around the armature, and improve the passage of fuel through the injector.

Features 50 located on the outside diameter surface 48 of armature 40 or in the body 49 of armature 40 may take on a number of shapes and forms. For example, features 50 located on the outside diameter surface 48 of armature 40 may include a plurality of straight flutes 54 formed substantially parallel with axis 30 (shown in FIGS. 3 and 4) or helical flutes (not shown). Features 50 may also include one or more circumferential grooves (not shown) on the armature's outer diameter surface proximate the middle of armature 40. Features 50, as axial through holes 52 or radial through holes (not shown), may also be formed in the body of the armature. Features 50 may be evenly spaced along outer diameter surface 48 of armature 40, as shown in FIG. 3, or may be unevenly spaced along outer diameter surface 48 of armature 40. Additionally, through holes, such as holes 56 may be placed at the inner circumference of armature 40.

While the grooves and flutes, in accordance with the invention, have been described as being formed on the outside diameter surface of the armature, the grooves and flutes may also be formed on the surface of the guide proximate the armature.

While the upper guide system has been described for a fuel injector for direct injection it may be applied to other solenoid actuated fuel injectors.

While exemplary forms of features 50 have been described, features 50 may take on other forms.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An upper guide system for a solenoid actuated fuel injector of an internal combustion engine, comprising:
A pintle having a cylindrical armature disposed at a first end, and a second end having a valve portion;
a guide ring circumferentially surrounding said armature wherein a contact surface between said armature and said guide ring of one or both of said armature or said guide ring includes features selected from the group consisting of one or more flutes and one or more circumferential grooves.

2. The upper guide system of claim 1, wherein said guide ring is disposed between said armature and a housing of said fuel injector.

3. The upper guide system of claim 2, wherein said guide ring is in a fixed position relative to said housing.

4. The upper guide system of claim 1, wherein a radial force imposed on said armature by a magnetic force induced by said solenoid is substantially aligned with said guide ring.

5. The upper guide system of claim 1, wherein said contact surface of said guide ring is hardened.

6. The upper guide system of claim 5 wherein said hardened contact surface is formed of martensitic stainless steel or chrome plated.

7. The upper guide system of claim 1, wherein a surface of said armature is formed of chromium or titanium nitride.

8. The upper guide system of claim 1 wherein said one or more flutes are straight.

9. The upper guide system of claim 1, wherein said armature includes a body portion, said body portion having at least one hole passing through said body portion.

10. The upper guide system of claim 9, wherein said at least one hole passes axially through said body portion.

11. An armature/pintle assembly of a solenoid actuated fuel injector of an internal combustion engine, comprising:
a pintle;
a cylindrical armature disposed at a first end of said pintle, said armature including an outer diameter surface and a body portion;
a valve portion disposed at a second end of said pintle; and
a guide ring circumferentially surrounding at least a portion of said outer diameter surface of said armature wherein said armature includes features disposed on said outer diameter surface and wherein said features are selected from the group consisting of one or more flutes and one or more circumferential grooves.

12. The armature/pintle assembly of claim 11, wherein said pintle, said armature and said valve portion are disposed within a housing of said solenoid actuated fuel injector for reciprocating axial movement within a fuel passage and constitute the moving mass of said fuel injector.

13. The armature/pintle assembly of claim 11, wherein an outer diameter of said guide ring is adapted to closely fit into a housing of said solenoid actuated fuel injector and an inner diameter of said guide ring is adapted to movably receive said armature.

14. The armature/pintle assembly of claim 11, wherein said one or more flutes are selected from one or more straight flutes disposed on said outer diameter of said armature and one or more helical flutes disposed on said outer diameter of said armature.

15. A solenoid actuated fuel injector for direct injection, comprising:
a housing enclosing a fuel passage;
an armature/pintle assembly disposed within said housing for reciprocating axial movement within said fuel passage, said armature/pintle assembly including a pintle having a cylindrical armature disposed proximate a first end, and a second end having a valve portion; and
a guide ring circumferentially surrounding said armature wherein one of said armature or said guide ring includes features selected from the group consisting of one or more flutes and one or more circumferential grooves.

16. The fuel injector of claim 15, wherein said armature includes a body portion having at least one hole passing through said body portion.

17. The fuel injector of claim 15, wherein said at least one hole is an axial through hole.
